(19) United States
(12) Patent Application Publication
(10) Pub. No.: US 2007/0133760 A1
(43) Pub. Date: Jun. 14, 2007

(54) Method and Apparatus for Providing Personalized Video Ring Back Greetings

(75) Inventors: Christopher J. Cotignola, Doylestown, PA (US); Larry T. Cullen, Souderton, PA (US); Thomas F. Kister, Chalfont, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/612,074

(22) Filed: Dec. 18, 2006

Related U.S. Application Data
(63) Continuation-in-part of application No. 11/298,029, filed on Dec. 9, 2005.

(51) Int. Cl. H04M 11/00

(52) U.S. Cl. 379/88.13

(57) ABSTRACT

A media clip, such as a video clip or an audio/video clip, is provided as a ringback tone for an incoming call. A specific media clip may be dedicated for specific callers or for a group of callers. A processor detects an incoming call and determines if a media clip is assigned for the caller based on communication information associated with the caller such as Caller ID. The processor may also determine that the original ringback tones should be provided to an individual caller. The media clips may be downloaded to the processor by a user and may be assigned to specific callers by the user.

This application is a continuation in part of U.S. Ser. No. 11/298,029 filed on Dec. 9, 2005, which is herein incorporated by reference in its entirety.

### FIELD OF THE INVENTION

The application relates to ringback greetings. More particularly, the application relates to providing personal ringback greetings to a caller.

### BACKGROUND

Several digital communication devices, such as cell phones, allow a user to program specific ringtones, media clips, and pictures which are produced by the user's own device when a call is received. Ringtone, media clips and pictures may be assigned for specific callers, allowing the user to quickly identify those callers by the ringtone, media clip or picture produced.

Signaling protocols used in digital networks, such as VoIP, provide specific protocols to connect a call. One of the protocols is for a party receiving an incoming call to generate an in-band ringback signal which is sent to the party initiating the call. Current digital voice services, such as cell phones, IP phones and VoIP, limit the calling party to be notified of a connection with the callee party by a simple ringback tone. This ringback tone lets the calling party know that the phone of the callee party is ringing and awaiting an answer. There are currently no known devices which allow a user callee party to provide personalized ringback tones to a calling party.

### SUMMARY

In accordance with the principles of the invention, a media clip may be provided in place of an original ringback tone.

An apparatus of the invention may comprise: a media ringback generator; a memory configured to store one or more media clips; and a processor configured to retrieve a media clip associated from the memory and provide the media clip to the media ringback generator in response to an incoming communication request, wherein the media clip includes video data.

The communication apparatus may further comprise a transceiver operable to receive incoming communication signals and transmit the retrieved media clip as a ringback tone to an incoming communication request. A unique media clip may be assigned for specific callers or a group of callers.

A method of providing a ringback tone in a communication system may comprise the steps of: receiving a request for communication from a caller; determining if a media clip is assigned to the caller; if a media clip is assigned to the caller, selecting an assigned media clip; and communicating the assigned media clip to the caller as a ringback tone, wherein the media clip includes video data.

A computer readable medium may contain instructions for a computer to perform a method of providing a ringback tone in a communication system comprising the steps of: receiving a request for communication from a caller; determining if a media clip is assigned to the caller; if a media clip is assigned to the caller, selecting an assigned media clip; and communicating the assigned media clip to the caller as a ringback tone.

Those of skill in the art will appreciate that the invention provides an attractive ringback to a caller by replacing a conventional ringback tone with a media clip. The caller also can readily determine if they dialed the correct number prior to the completion of the call by an answer by a user or answering machine by listening for the media clip assigned to them.

### BRIEF DESCRIPTION OF THE DRAWINGS

FIG. 1 illustrates an exemplary network in which the communication device of FIG. 2 may operate;

FIG. 2 illustrates an exemplary communication device in accordance with the principles of the invention;

FIG. 3 illustrates an exemplary process for assigning media clips to callers; and

FIG. 4 illustrates an exemplary process for sending media clips to callers.

### DETAILED DESCRIPTION

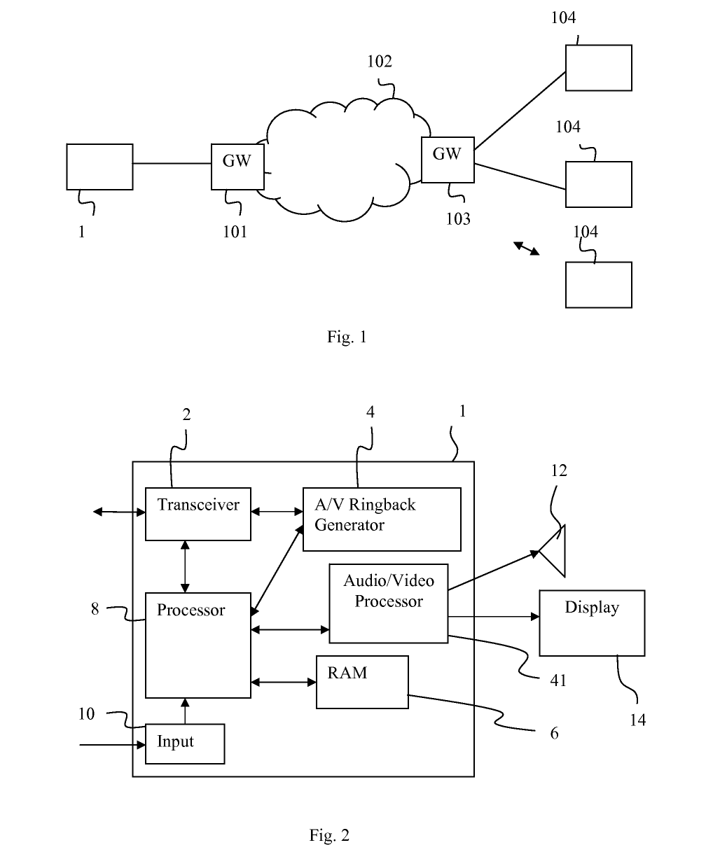

FIG. 1 illustrates an exemplary network in which communication device 1 may operate. As generally illustrated in FIG. 1, communications device 1 is preferably located on a user's premises and interfaces to a network 102 through a gateway 101. The communication with a caller 104 is completed through network 102 and gateway 103. Those of skill in the art will appreciate that gateways 101 and 103 may be any suitable type of gateway to pass a corresponding communication signal to and from network 102, such as a CMTS (cable modem termination system) in an HFC system (hybrid fiber coax) or appropriate switching devices in a PSTN or GSM or CDMA network. Caller 104 and/or communication device 1 may be wireline or wireless devices.

FIG. 2 illustrates an exemplary communications device 1 which may operate in accordance with the principles of the invention. Communications device 1 may be included in a video capable device such as a set top box, video phone (e.g. Ojo™), a Cordless Embedded Multi-media Terminal Adaptor (CEMTA), such as Motorola SBV5422, or an IP phone, including VoIP phones or a digital cellular phone operating on a digital network such as a CDMA or GSM network.

As shown in FIG. 2, a transceiver 2 is configured to send and receive modulated digital voice communication signals, preferably via a wireline transmission according to appropriate communications protocols, such as DOCSIS. A coaxial cable may be used as a communication medium which connect communications device 1 to an upstream hybrid fiber cable (HFC) network. Those of skill in the art will appreciate that an optical fiber may be used as the communications medium through which transceiver 2 communicates and may be part of an HFC network or all fiber network, e.g. a “fiber to the curb” network. The term “network”, as used herein refers to any suitable communication network which enables voice communications, including an HFC network, a PSTN network, an optical fiber network, a cellular network, and any combinations thereof.

Preferably, transceiver 2 provides received communication signals to processor 8, which preferably demodulates and processes the communication signals into a form which allows video and audio voice data to be provided to a user via a telephone interface. Processor 8 is further configured to detect the initiation of a call, e.g. a connection, with communications device 1. Preferably, processor 8 receives an indication of an incoming call from the network, or more specifically from a call management agent in the network. Upon detection of an incoming call, processor 8 instructs A/V media ringback generator 4 to produce ringback tones in the form of an audio/video clip or video clip, which are provided to transceiver 2 and communicated through the network to the caller using communication protocols associated with the network on which communication device 1 is connected. For example, the media clip ringback may be provided to the caller through the network as an in-band ringback tone or sent as a multimedia file and may be provided in various compression schemes such as MPEG 2, or MPEG 4 or H.264. Those of skill in the art will appreciate that an audio/video clip may be any form of continuous audio/video data, such as a photograph, a video segment, an advertisement, a portion or clip of a song or spoken message or other types of audio/video content. Those of skill in the art will also appreciate that an “original ringback tone”, as used herein, means a periodic repeating ringback tone which a communication device originally produces to indicate a ringing operation.

A user may instruct processor 8 to provide a personalized audio video clip ringback through user input 10. User input 10 may constitute any known user input, including a keypad, a data port, camera and the like. Processor 8 may access the Internet to download selected audio video clips through the network and transceiver 2. The clips may be offered for download by the network provider to the communication device and may be provided for a fee or as part of a subscription service. Media clips may also be provided to processor 8 through a data port (not shown) such as a USB port or any suitable data port. Processor 8 preferably stores the selected clips in RAM 6 and retrieves the clips when an incoming call is detected. The retrieved clips are provided to media ringback tone generator 4 by processor 8 and then provided to transceiver 2 to be communicated to the caller through the network.

Processor 8 may select the same clip ringback for each incoming call or may provide unique clip ringback for individual callers or groups or types of callers. For example, a close friend of the user may be provided a specific clip ringback associated with their friendship and a parent of the user may be provided with another clip ringback. In another example, calls from co-workers or work related calls may receive a clip ringback associated with the user's work, and personal calls may receive a separate clip ringback. In another example, a business may provide an advertisement as a ringback clip, such as sale videos or a jingle.

The implementation illustrated in FIG. 2 may also play media clips received as ringback tones from other devices. Preferably, a media clip ringback tone received by transceiver 2 is provided to microprocessor 8 where it is demodulated and provided to audio/video media processor 41. Audio/video media processor 41 preferably decompresses the media clip, if it is compressed, and processes it to be provided to display 14 and/or speaker 12.

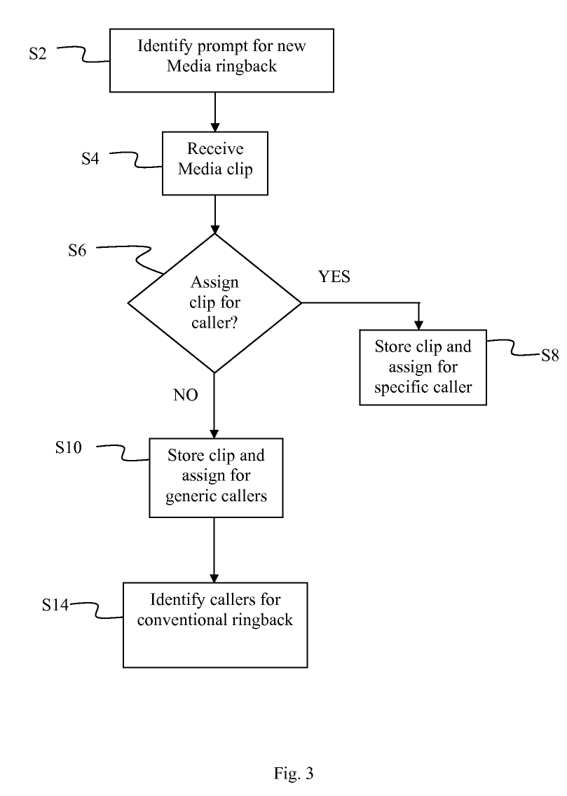

FIG. 3 illustrates an exemplary method for assigning clips as a ringback. As illustrated in step S2 of FIG. 3, a user may be requested to identify a prompt for a new ringback, such as by entering a code in a keypad of the telephone or by using a computer interface with processor 8 which enables the user to program processor 8. Processor 8 then receives the clip as illustrated in step S4 from any suitable data input source, such as a USB connection or internet connection. Processor 8 determines if the received clip should be assigned for an individual caller or a group of callers, step S6, YES and step S8. If the clip is not to assigned for specific callers, step S6, NO, then the clip is stored and assigned for generic callers, e.g. unclassified callers. In step S14, the process may also include a step of identifying specific callers or a group of callers which should receive a conventional ringback tone, such as callers who may be startled or offended by an clip ringback tone.

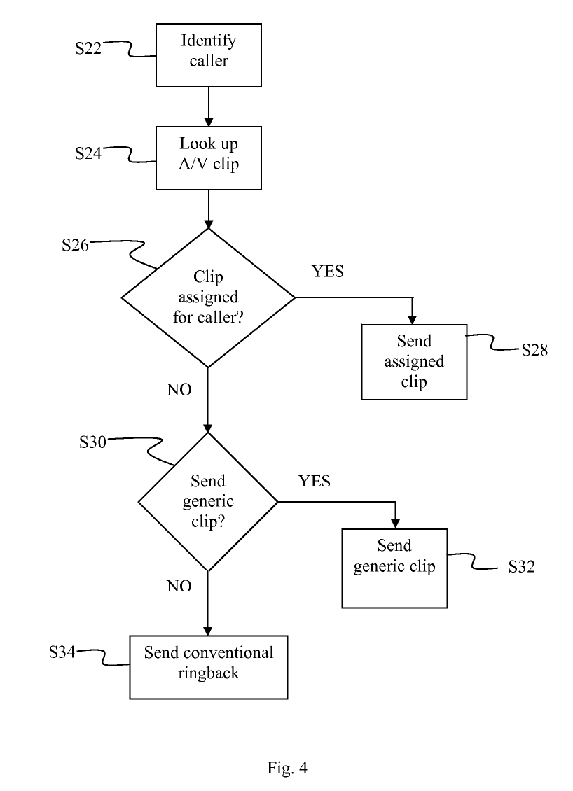

FIG. 4 illustrates an exemplary process for providing a clip ringback tone. As illustrated in FIG. 4, a caller associated with an incoming call is identified, step S22. Those of skill in the art will appreciate that the caller may be identified based on their phone number using conventional caller ID techniques. As illustrated in step S24, processor 8 determines if a media clip has been assigned for the caller or a group with which the caller is associated. If a media clip has been assigned for the caller, step S24, YES, then the media clip is retrieved from memory 6 and provided to A/V media ringback tone generator 4. If a media clip has not been assigned for the caller, step S24, NO, processor 8 determines if a generic media clip should be played, step S30. If the caller has been designated not to have a media clip provided as the ringback tone, step S30, NO, then a conventional ringback tone is provided in step S34, otherwise, the generic media clip is provided in step S30, YES and step S32.

The invention may also be configured to play no ringback at all for certain calls. This may prevent telemarketers or unwanted callers from calling, since many automatic dialers verify a connection by waiting for a ringback tone to verify that the called number is in service. Accordingly, if an automatic dialer does not hear a ringback tone, it may abandon the call.

Those of skill in the art will appreciate that in accordance with the invention, for videophones, such as one under the trade name Ojo™, when a calling party is waiting for the called party to answer the call, the calling party may see a personalized video clip or photograph that the called party configured as their ringback until the call is answered. For telephony enabled set top boxes, when placing a call, the television of the calling party may display the video clip or photographs of the called party that the called party configured as their ringback until the call is answered.

The processes in FIGS. 3 and 4 may be implemented in hard wired devices, firmware or software running in a processor. A processing unit for a software or firmware implementation is preferably contained in the user device. The processes illustrated in FIGS. 3 and 4 may be contained on a computer readable medium which may be read by microprocessor 102. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Those of skill in the art will appreciate that the invention provides an attractive ringback to a caller by replacing a conventional ringback tone with an audio/video media clip. The caller also can readily determine if they dialed the correct number prior to the completion of the call by an answer by a user or answering machine by listening for the media clip assigned to them. The invention also allows a user to personalize their ringback tone and to allow businesses provide immediate advertising to potential customers.

Those of skill in the art will appreciate that other modifications may be implemented without departing from the scope and spirit of the invention.

What is claimed is:

1. A communication apparatus comprising:
a media ringback generator;
a memory configured to store one or more media clips; and
a processor configured to retrieve a media clip associated from the memory and provide the media clip to the media ringback generator in response to an incoming communication request,
wherein the media clip includes video data.

2. The communication apparatus of claim 1, further comprising a transceiver operable to receive incoming communication signals and transmit the retrieved media clip as a ringback tone to an incoming communication request.

3. The communication apparatus of claim 1, wherein the processor is configured to retrieve the media clip based on an identification of a caller associated with an incoming communication request.

4. The communication apparatus of claim 3, wherein a unique media clip is assigned for specific callers.

5. The communication apparatus of claim 3, wherein a media clip is assigned for a group of callers.

6. The communication apparatus of claim 1, further comprising an input device which allows a user to input media clips and to provide instructions to the processor, wherein the processor determines which callers to assign the inputted media clips based on user instructions.

7. A method of providing a ringback tone in a communication system comprising the steps of:
receiving a request for communication from a caller;
determining if a media clip is assigned to the caller;
if a media clip is assigned to the caller, selecting an assigned media clip; and
communicating the assigned media clip to the caller as a ringback tone,
wherein the media clip includes video data.

8. The method of claim 7, wherein the step of determining if a media clip is assigned to the caller determines if the media clip is assigned to a group associated with the caller.

9. The method of claim 7, wherein the step of determining if a media clip is assigned to the caller determines if the media clip is uniquely assigned to the caller.

10. The method of claim 7, wherein the step of determining if a media clip is assigned to the caller determines if the caller should receive an original ringback tone.

11. The method of claim 7, further comprising the step of receiving an external media clip from an external source and receiving instructions from a user to assign the external media clip to at least one caller.

12. A computer readable medium containing instructions for a computer to perform a method of providing a ringback tone in a communication system comprising the steps of:
receiving a request for communication from a caller;
determining if a media clip is assigned to the caller;
if a media clip is assigned to the caller, selecting an assigned media clip; and
communicating the assigned media clip to the caller as a ringback tone.

13. The computer readable medium of claim 12, wherein the step of determining if a media clip is assigned to the caller determines if the media clip is assigned to a group associated with the caller.

14. The computer readable medium of claim 12, wherein the step of determining if a media clip is assigned to the caller determines if the media clip is uniquely assigned to the caller.

15. The computer readable medium of claim 12, wherein the step of determining if a media clip is assigned to the caller determines if the caller should receive an original ringback tone.

16. The computer readable medium of claim 12, wherein the method further comprises the step of receiving an external media clip from an external source and receiving instructions from a user to assign the external media clip to at least one caller.
